(19) United States
(12) Patent Application Publication
(10) Pub. No.: US 2024/0020437 A1
(43) Pub. Date: Jan. 18, 2024

(54) SYSTEMS AND METHODS FOR GENERATING COMPUTATIONAL MODELS OF MATERIALS, INTERFACES, AND DEVICES

(71) Applicant: Purdue Research Foundation, West Lafayette, IN (US)

(72) Inventors: Tillmann C. Kubis, West Lafayette, IN (US); Han-Wei Hsiao, West Lafayette, IN (US)

(21) Appl. No.: 18/221,839

(22) Filed: Jul. 13, 2023

Related U.S. Application Data
(60) Provisional application No. 63/388,997, filed on Jul. 13, 2022.

(51) Int. Cl. G06F 30/20

(52) U.S. Cl. CPC G06F 30/20

(57) ABSTRACT

A method of generating a computational model includes generating a set of benchmark parameters indicative of material properties of a reference material system through performance of at least one of a simulation of, or an experiment on, a subset of the reference material system, generating a plurality of DFTB parameters for the reference material system, performing an optimization routine to adjust each DFTB parameter of the plurality of DFTB parameters to improve accuracy relative to the set of benchmark parameters of the reference material system, and storing an optimized set of DFTB parameters corresponding to the material properties of the reference material system.

### CROSS-REFERENCE TO RELATED APPLICATIONS

This application is related to and claims the priority benefit of U.S. Provisional Patent Application No. 63/388,997, entitled “DFTB Parameterization Method for Reproducing Various Observables,” filed Jul. 13, 2022, the contents of which are hereby incorporated by reference in their entirety into the present disclosure.

### TECHNICAL FIELD

The present application relates to material modeling, and specifically to methods for generating density functional tight binding parameterizations to create computational models of materials, interfaces, and devices.

### BACKGROUND

This section introduces aspects that may help facilitate a better understanding of the disclosure. Accordingly, these statements are to be read in this light and are not to be understood as admissions about what is or is not prior art.

The density functional tight binding (DFTB) method is a quantum mechanical approach used in computational chemistry to study the electronic structure and properties of molecules, clusters, and extended systems. It is an approximate method that combines elements of density functional theory (DFT) and tight binding theory. In DFTB, the electronic structure of a system is described using a set of atom-centered orbitals rather than the more computationally expensive plane wave basis sets used in traditional DFT calculations. The method employs a simplified Hamiltonian matrix that approximates the electronic interactions within a system. These approximations allow for significant computational speed-up compared to more rigorous quantum mechanical methods.

DFTB is particularly useful for studying large systems, such as biomolecules, nanoparticles, and surfaces, where traditional quantum mechanical methods are computationally expensive or infeasible. The most common way to parameterize DFTB is to parameterize atom-atom bonds in an arbitrarily chosen molecule and transfer that bond parameter to any other situation irrespective of in which material or molecule the corresponding atoms appear. However, this approach includes drawbacks, such as being inaccurate for distinguishing between different materials. Therefore, improvements to these methods are needed for more accurately and efficiently predicting material properties.

### SUMMARY

Aspects of this disclosure describe systems and methods for generating computational models of materials. Methods can include generating a set of benchmark parameters indicative of material properties of a reference material system through performance of at least one of a simulation of, or an experiment on, a subset of the reference material system. Further, the methods can include generating a plurality of DFTB parameters for the reference material system and performing an optimization routine to adjust each DFTB parameter of the plurality of DFTB parameters to improve accuracy relative to the set of benchmark parameters of the reference material system. Finally, methods can include storing an optimized set of DFTB parameters corresponding to the material properties of the reference material system. Storing the optimized set of DFTB parameters can, in some applications, include assigning the optimized set of DFTB parameters to a transferability space. The transferability space can be configured to correlates the optimized set of DFTB parameters with one or more applicable material systems or material interfaces.

In some embodiments, generating the set of benchmark parameters can include performing a density functional theory (DFT) simulation of a subset of the reference material system. Further, other embodiments can include optimizing a subset of the plurality of DFTB parameters to generate a second simulation output of the subset of the reference material system according to a target accuracy relative to the set of benchmark parameters.

In certain applications, benchmark parameters can include at least one of a band structure, a piezoelectric coefficient, a screening constant, a charge distribution, an optoelectronic parameter, or a mechanoelectrical parameter of the reference material system. Further, the plurality of DFTB parameters of the reference material system can include at least one of electronic parameters, repulsive potentials, ionic parameters, or ideal distance between coupling atoms.

This summary is provided to introduce a selection of the concepts that are described in further detail in the detailed description and drawings contained herein. This summary is not intended to identify any primary or essential features of the claimed subject matter. Some or all of the described features may be present in the corresponding independent or dependent claims, but should not be construed to be a limitation unless expressly recited in a particular claim. Each embodiment described herein does not necessarily address every object described herein, and each embodiment does not necessarily include each feature described. Other forms, embodiments, objects, advantages, benefits, features, and aspects of the present disclosure will become apparent to one of skill in the art from the detailed description and drawings contained herein. Moreover, the various apparatuses and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

While the specification concludes with claims which particularly point out and distinctly claim this technology, it is believed this technology will be better understood from the following description of certain examples taken in conjunction with the accompanying drawings, in which like reference numerals identify the same elements and in which:

FIG. 1 depicts a schematic diagram of one example h-BN/h-BP heterobilayer structure, showing the angle between the dipole vectors of upper h-BN layer (the blue arrow) and the lower h-BP layer (the red arrow) representing the twist angle;

FIG. 2 depicts a graphical comparison of the band structures of the example heterobilayer system of FIG. 1, with the yellow dots being calculated by density-functional based tight-binding (DFTB) using parameterized DFTB parameters, the green lines being solved using the DFT using Heyd-Scuseria-Ernzerhof (HSE06) exchange-correlation functional;

FIG. 3 depicts a graphical representation of the applied uniaxial strain along the x-axis results in a change in polarization along the same axis for monolayer h-BN;

FIG. 4 depicts a graphical representation of the average interlayer distance and its standard deviation of h-BN/h-BP heterobilayer structures with various twist angles as a function of supercell size;

FIG. 5 depicts a graphical three-dimensional (3D) visualization of the average interlayer spacing of the relaxed h-BN/h-BP heterobilayer system twisted at θ=10 degrees and the corresponding corrugation landscape projection on the xy-plane;

FIG. 6 depicts a graphical representation of the in-plane piezoelectric coefficients, shown as black and gray, of twisted h-BN/h-BP heterostructures versus the twist angle, with the symbols and the dotted lines representing the DFTB results and the analytical formulas derived from isolated monolayers, respectively;

FIG. 7 depicts a graphical representation of the in-plane piezoelectric coefficients e₁₁ (black) and e₂₂ (gray) of twisted h-BN/MoS2 heterostructures versus the twist angle, with the symbols and the dotted lines representing the DFTB results and the analytical formulas derived from isolated monolayers, respectively;

FIG. 8 depicts a graphical comparison between the out-of-plane piezoelectric coefficient relative to the average interlayer distance, with the solid line representing the out-of-plane piezoelectric coefficient e₃₃ of h-BN/h-BP heterobilayer structures, and with the dashed line representing the average interlayer spacing of the same system as a function of twist angle;

FIG. 9 depicts a graphical comparison between the out-of-plane piezoelectric coefficient relative to the average interlayer distance, with the solid line representing the out-of-plane piezoelectric coefficient e₃₃ of h-BN/MoS2 heterobilayer structures, and the dashed line representing the average interlayer spacing as a function of twist angle;

FIG. 10 depicts one example method of generating a computational model of a material system; and

FIG. 11 depicts a block diagram showing components of one example system configured for generating computational models of material systems.

The drawings are not intended to be limiting in any way, and it is contemplated that various embodiments of the technology may be carried out in a variety of other ways, including those not necessarily depicted in the drawings. The accompanying drawings incorporated in and forming a part of the specification illustrate several aspects of the present technology, and together with the description serve to explain the principles of the technology; it being understood, however, that this technology is not limited to the precise arrangements shown, or the precise experimental arrangements used to arrive at the various graphical results shown in the drawings.

### DETAILED DESCRIPTION

The following description of certain examples of the technology should not be used to limit its scope. Other examples, features, aspects, embodiments, and advantages of the technology will become apparent to those skilled in the art from the following description, which is by way of illustration, one of the best modes contemplated for carrying out the technology. As will be realized, the technology described herein is capable of other different and obvious aspects, all without departing from the technology. Accordingly, the drawings and descriptions should be regarded as illustrative in nature and not restrictive.

It is further understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

Reference systems that may be used herein can refer generally to various directions (for example, upper, lower, forward and rearward), which are merely offered to assist the reader in understanding the various embodiments of the disclosure and are not to be interpreted as limiting. Other reference systems may be used to describe various embodiments, such as those where directions are referenced to the portions of the device, for example, toward or away from a particular element, or in relations to the structure generally (for example, inwardly or outwardly).

### I. Overview

Piezoelectric two-dimensional (2D) materials have attracted growing interests in the fields of piezotronics and nanoelectromechanical systems, such as actuators, transducers, and energy harvesters. The piezoelectric coefficients of bilayer systems have been found in some instances to significantly exceed the sum of the respective monolayers. There is experimental evidence that indicates twist angles offer relevant design and control aspects for engineering the piezoelectricity of vdW bilayer systems. For instance, some stacking orders of hexagonal boron nitride (h-BN) bilayers induce out-of-plane polarizations, and some twisted bilayer graphene was found to produce flexoelectricity.

Heterobilayer materials, also known as heterostructures or heterojunctions, are composite structures consisting of two or more different layers of materials stacked on top of each other. These layers are made of distinct materials with unique properties, such as different crystal structures, bandgaps, or electronic characteristics. Heterobilayer materials have attracted attention in the field of materials science and condensed matter physics due to their unique properties and potential applications. The interface between the layers can give rise to novel phenomena and enable the manipulation of electronic, optical, and magnetic properties.

The below description focuses to the impact of the twist angle on the piezoelectric coefficients of vdW heterobilayers, as described relating to example embodiments of h-BN/h-BP (hexagonal boron phosphide) and h-BN/MoS2 (molybdenum disulfide) heterobilayer systems. While h-BN/h-BP and h-BN/MoS2 heterobilayer systems are described herein as examples to illustrate the novel systems and methods, it should be understood that the concepts described herein are applicable to a wide range of heterobilayer systems and should not be constrained to only the described h-BN/h-BP and h-BN/MoS2 heterobilayer systems. Importantly, the methods described herein are also more widely applicable to any other materials (e.g., monolayer 2D materials, dimers of pairs of atoms, heterojunctions, three-dimensional materials), to any defects in materials, or to any other alterations of the materials. For any material, the methods described advantageously generate DFTB parameter sets for efficient and accurate predictions of material properties or for performing simulations (e.g., quantum transport simulations with the DFTB Hamiltonians).

As one example, as will be described in greater detail below, the analytical description of the angle-dependence of the in-plane piezoelectric coefficient is often correct for idealized vdW heterobilayer systems but can deviate increasingly from the density-functional based tight-binding (DFTB) calculations depending on the coupling strength between the layers. To obtain accurate and reliable predictions, all possible internuclear repulsion energies and long-distance effects caused by twist angle, corrugation, and strain, may be carefully included in terms of well-converged observables relative to supercell sizes. However, numerical load of density-functional theory (DFT) calculations may restrict or prohibit expanding the supercells of heterobilayer systems with arbitrary twist angles to full convergence. Third order density-functional based tight-binding theory (DFTB3) is capable of modeling systems containing thousands of atoms and is therefore applied as described herein. This extended DFTB approach allows for calculations of the piezoelectricity in fully relaxed, twisted, and corrugated vdW heterobilayer systems. The DFTB parameters are optimized to accurately reproduce the DFT band structures and piezoelectric coefficients of the respective monolayers and untwisted heterobilayer using Heyd-Scuseria-Ernzerhof (HSE06) exchange-correlation functional as implemented in the Vienna Ab initio Simulation Package (VASP) code. In other applications, such as depending on the material(s), other functionals such as HSE03, LDA-1/2, or G0W0, may be utilized. A periodic relationship between twist angle and the in-plane coefficients is observed in both h-BN/h-BP and h-BN/MoS2 heterobilayer simulations. Moreover, the calculated e₁₁ and e₂₂ of h-BN/h-BP systems deviate further from the symmetry predicted by the analytical model, which is an indication that stronger interlayer coupling exists in such systems. In contrast, the out-of-plane piezoelectric response appears to be nearly independent of the twist angle. All these findings shed light on the design and optimization of the piezoelectricity in vdW hetero structures.

### II. Exemplary Computational Methods for Generating Computational Models of Materials, Interfaces, and Devices

A. Geometry of the Materials

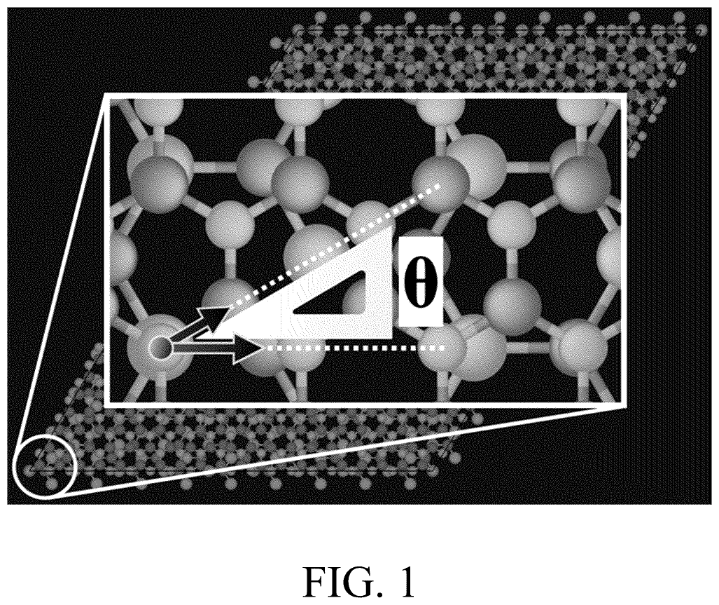

The following method is applied on both DFT and the corresponding DFTB simulations and experiments. Monolayers (h-BN, h-BP, and MoS2) are constructed from the primitive hexagonal unit cell. The lattice constants and internal coordinates are allowed to fully relax until the maximum force exerted on each atom are smaller than 0.01 eV Å⁻¹. The initial commensurate supercell of the heterobilayer is created by stacking the separately optimized monolayers on top of each other with artificial boundary condition using the CellMatch code with the dipole vectors of the two layers right above each other and pointing toward the +x direction. To make a twist angle of θ in the initial supercell setup, the upper layer is rotated by the angle of θ with respect to original orientation. θ is the angle defined by the two dipole vectors as shown in FIG. 1. Then the bilayer structure is relaxed until the maximum force on each atom is less than 0.01 eV Å⁻¹. The size of the imposed artificial strain depends on the size of the considered supercell of the bilayer structures. As detailed in later paragraphs, DFTB simulations allow increasing the size of the supercells until convergence of all observables is found. Typically, a supercell containing several hundreds of atoms is required for an accurate prediction on the heterobilayer piezoelectric coefficients. Detailed findings on the supercell sizes required for convergence are discussed in the final subsection. The atomic coordinates of a relaxed bilayer structure may deviate from their original values due to intralayer and interlayer interactions. Corrugation is defined by the average deviation of the distance between nearest neighbors of different layers from the average interlayer distance (due to relaxation).

B. Piezoelectric Coefficient Calculations of the Materials

In Voigt notation the general piezoelectric tensor is represented as a 3×6 matrix eᵢⱼ where 1≤i≤3 and 1≤j≤6. Unperturbed h-BN, h-BP, and MoS2 monolayers possess a 6̅m2 point-group symmetry and there is only one independent piezoelectric coefficient. According to the geometric phase approach, piezoelectric coefficients may be solved by the differential change of 2D polarization with respect to uniaxial strain in a range from −0.015 to 0.015 in steps of 0.005 (see, FIG. 3). Atomic positions are relaxed at each strain step to generate the relaxed-ion piezoelectric coefficients. The clamped-ion piezoelectric coefficients are calculated with the same geometric phase approach procedure but without relaxing atomic positions at each strain configuration. The numerical load of DFT calculations prohibit expanding the supercells of heterobilayer systems with arbitrary twist angles to full convergence. To obtain a reliable piezoelectricity prediction, the geometry model of twisted bilayer may need to be sufficiently large until the error of each observable is smaller than 5%.

C. Example DFTB3 Method for Calculating Piezoelectricity of the Materials

Known aspects of the DFTB3 method are summarized for later reference in the following subsection. The DFTB method solves Kohn-Sham equations with low enough computational load to allow for simulations with more than a thousand of atoms. The third-order Taylor expansion of the DFT total energy functionals around a chosen reference density ρ₀(r), which is the superposition of electron densities of neutral atoms, can be expressed as:

E_{DFTB3}[ρ₀+δρ]≈E_{DFTB1}[ρ₀]+E_{γ}[ρ₀,(δρ)²]+E_{Γ}[ρ₀,(δρ)³]

Note the first order expansion term is cancelled by elements of the second order. The first order term E_{DFTB1}[ρ₀] can be further divided into two parts:

$${E}_{DFTB 1} [ {ρ}_{0} ] = {\sum }_{i} {n}_{i} 〈 {ψ}_{i} ( r ) \vert \hat{H} [ {ρ}_{0} ] \vert {ψ}_{i} ( r ) 〉 + \frac{1}{2} {\sum }_{ab} {V}_{ab}^{rep} [ {ρ}_{0}^{a} , {ρ}_{0}^{b} , {R}_{ab} ]$$

where nᵢ represents the occupation number of a molecular orbital ψᵢ and V_{ab}^{rep} denotes the distance-dependent repulsive potential between atoms a and b, which is determined as explained in the DFTB parameterization section. ρ₀^{a} and ρ₀^{b} are reference densities of the respective atoms, and R_{ab} is their interatomic distance. The molecular orbital ψᵢ(r) can be written as a linear combination of pseudoatomic orbitals:

$${ψ}_{i} ( r ) = {\sum }_{a} {\sum }_{μ} {c}_{μ i} {ϕ}_{μ} ( r - {R}_{0} )$$

where ϕ_{μ} is the basis function of orbital μ centered at atom a located at Rₐ and c_{μi} is the basis set coefficient. Pseudoatomic orbitals ϕ_{μ} are determined by solving the Kohn-Sham equations with a confining potential \hat{V}_{conf,μ}(r):

[\hat{T}+\hat{V}(r)+\hat{V}_{conf,μ}(r)]ϕ_{μ}(r)=ϵ_{μ}ϕ_{μ(r)}
where \hat{T} is the kinetic energy operator and \hat{V} is composed of external potential, Coulomb repulsion, and exchange correlation energy. The confining potential operator \hat{V}_{conf,μ} reads on its diagonal:

$${\hat{V}}_{conf , μ} ( r ) = {( \frac{{r}_{μ}}{{r}_{0 , μ}} )}^{{σ}_{μ}}$$

where the confinement radius r_{0,μ} and the exponent σ_{μ} are fitted parameters as discussed in the next section. We use as additional fitting parameters the orbital energies of the free spherical atoms ϵ_{μ}^{free}, which is defined in. Note that the off-diagonal elements of the Hamiltonian are computed by:

H_{μv}⁰= [symbol] ϕ_{μ}|Ĥ[ρ₀]|ϕᵥ [symbol] ≈ [symbol] ϕ_{μ}|\hat{T}+\hat{V}[ρₐ+ρ_{b}]|ϕᵥ

[symbol]

The second-order E_{γ} and third-order E_{Γ} terms are higher order corrections to the total electronic energy in self-consistent-charge DFTB. They are associated with chemical hardness and its derivative respectively, which are computed directly from DFT.

D. Example DFTB Parameterization of the Heterobilayer Materials

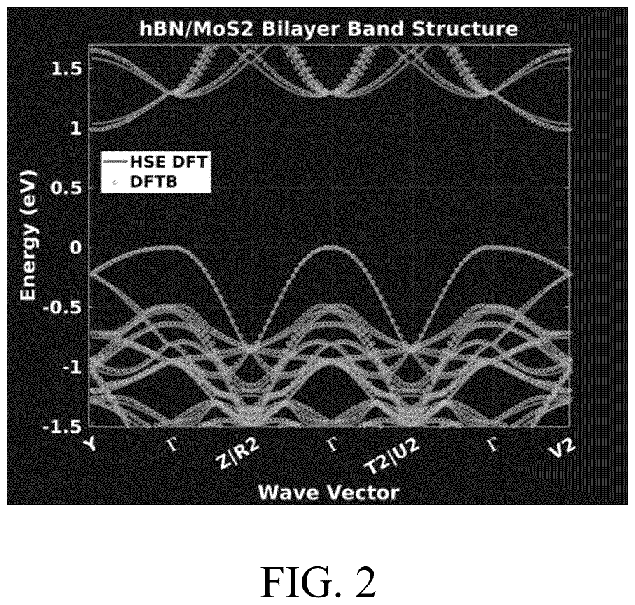

All fitting parameters previously mentioned are considered to be material- and orbital-dependent. They depend on atom types, in this work Mo, S, B, and N atoms, as well as the angular momentum of the respective atomic orbital (s, p, and d). All parameters are fitted so that DFTB results for the band structures and piezoelectric coefficients agree with the respective results of DFT calculations with HSE06 functionals solved by VASP. An accurate prediction of the piezoelectric coefficients may require even deeper lying valence bands of DFTB to agree very well with DFT results (see, FIG. 2).

Repulsive potentials may be dependent on atom types only and typically assumed to be transferable between different materials. Herein, a two-step fitting process can be applied to obtain all the repulsive potentials. First, the preliminary repulsive potentials are extracted from the energy differences between DFT HSE06 data and DFTB calculations. Next, all the relevant repulsive potentials are fitted simultaneously and iteratively with the genetic algorithm until the DFT HSE06 results are reproduced, more particularly until the band structures and the piezoelectric coefficients of reference systems are accurately reproduced. To cover different types of interactions, including intralayer and interlayer interactions, repulsive potentials are fitted to a range longer than the distance between nearest neighbors. In some embodiments, repulsive potentials (e.g., Mo-Mo) are fit not only to the corresponding atom pairs (e.g., Mo2 dimer), but also to all relevant monolayer (e.g., MoS2) and bilayer (e.g., hBN/MoS2) structures to account for the overall effect when other atom types are present. To ensure transferability, the reference systems considered in the repulsive potential parameterizations include all respective monolayers, heterobilayers, and all relevant atom pairs (dimers). The fitting target is to minimize the total energy differences between DFT and DFTB calculations of all reference systems simultaneously. The quality of the repulsive potential is sensitive to the choice of division points and the smoothness of the interpolation between them. Both may be chosen carefully to avoid deviations of the DFTB-predicted piezoelectricity from DFT results. To avoid unphysical forces exerted on atoms, repulsive potentials are described by a fourth-order spline function, which is continuously differentiable up to the second-order derivative in each interval. In addition to the total energy, a constraint is can be imposed that the fitted repulsive potentials reproduce the ionic contribution to the piezoelectric tensor of the monolayers.

### III. Results and Discussion of the Described Computational Methods

A. Discussion Regarding Parameter Transferability

The DFTB parameters may be chosen to accurately reproduce DFT monolayer and untwisted heterobilayer band structures of VASP HSE06 calculations. For an accurate and reliable piezoelectric coefficient prediction with DFTB, deep lying valence bands of DFT calculations may be faithfully reproduced (see, FIG. 2), since the polarization mostly depends on the ionic cores and the occupied valence bands. Results indicate that both the DFTB-calculated ionic and the electronic contributions to the piezoelectric coefficient e₁₁ agree with HSE06 DFT data and are transferable to all relevant strain constellations, as shown in FIG. 3.

B. Discussion Regarding Convergence and Supercell Size

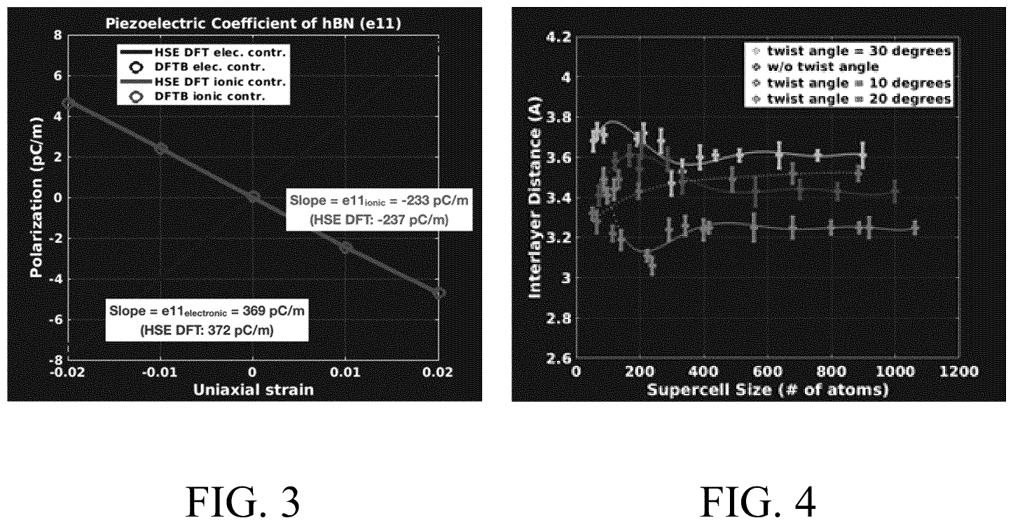

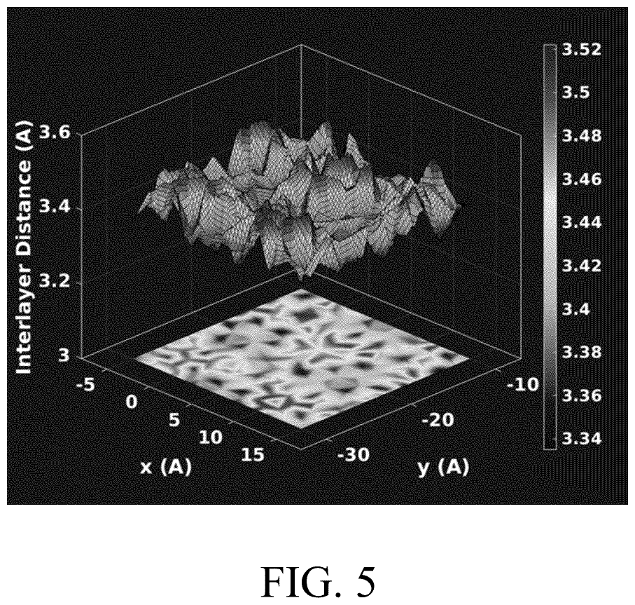

For twisted heterobilayer structures, a well-converged simulation may require sufficiently large initial supercells. FIG. 4 illustrates that the interlayer distance gradually converges with respect to the supercell size. Before convergence, the average interlayer spacing can vary significantly and rapidly with the supercell size. Typically, a supercell containing several hundreds of atoms is necessary for well-converged piezoelectricity calculations (see, FIG. 4). A geometry model with more than 1,000 atoms can be required for the systems with long commensurate unit cell lengths. This convergence affects all observables including piezoelectric coefficients and elastic constants. Therefore, for all the simulations described, the supercells have been extended until convergence was achieved, which resulted in systems of at least 600 atoms. FIG. 5 shows the in-plane resolved interlayer distance and the corresponding corrugation landscape projection on the xy-plane of the corrugated h-BN/h-BP heterobilayer with a twist angle of 10 degrees.

C. Discussion Regarding In-Plane Piezoelectric Coefficients

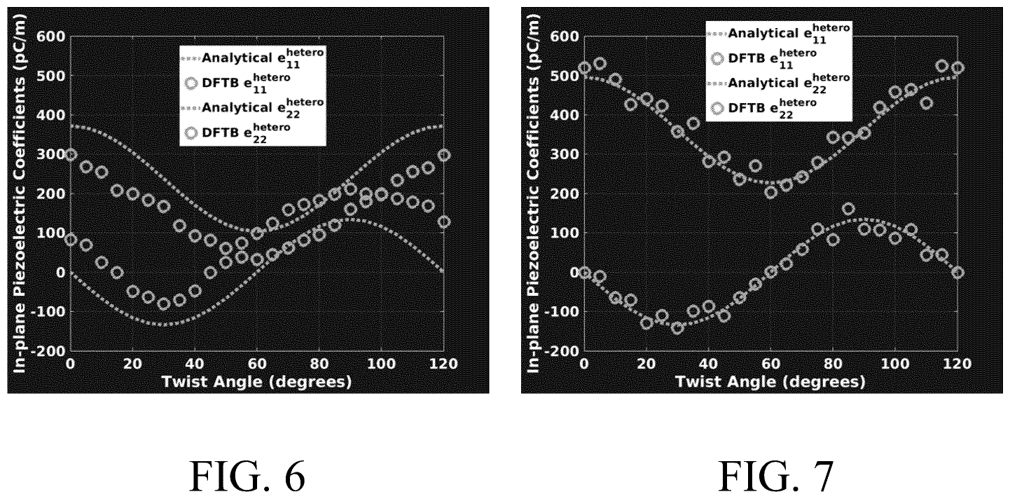

FIGS. 6 and 7 show the DFTB-calculated in-plane piezoelectric coefficients e₁₁ (black symbols) and e₂₂ (grey symbols) of twisted h-BN/h-BP and h-BN/MoS2 heterobilayer structures as a function of twist angle, respectively. In both figures, results of an analytical formula for the respective idealized, non-corrugated bilayer systems are shown (dashed lines). These idealized results neglect any interlayer coupling:

e₁₁^{hetero}=e₁₁^{hBN} cos(3θ)+e₁₁^{MoS2/hBP}

e₂₂^{hetero}=−e₁₁^{hBN} cos(3θ)+e₂₂^{MoS2/hBP}

The calculated results of the twisted bilayer system deviate from the idealized results for all twist angles depending on the charge transfer between the layers, the break of inversion symmetry, corrugations, and nonlinear, twist angle dependent interference effects of the same. The twisted h-BN/h-BP system shows a larger deviation from this idealized result than h-BN/MoS2 which indicates a stronger interlayer coupling in h-BN/h-BP. The 120 degrees periodicity of the idealized system is still maintained when realistic interlayer coupling is considered. Nevertheless, FIGS. 6 and 7 show the tunability of the piezoelectricity of heterobilayers as a function of twist angle.

D. Discussion Regarding Out-Of-Plane Piezoelectric Coefficients

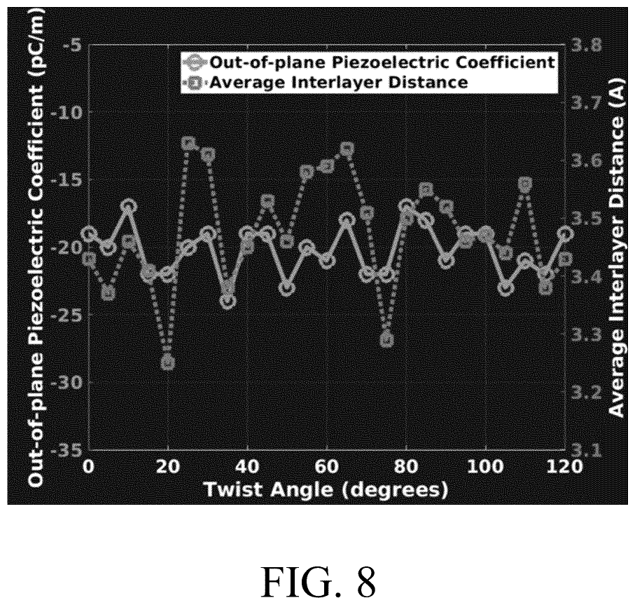

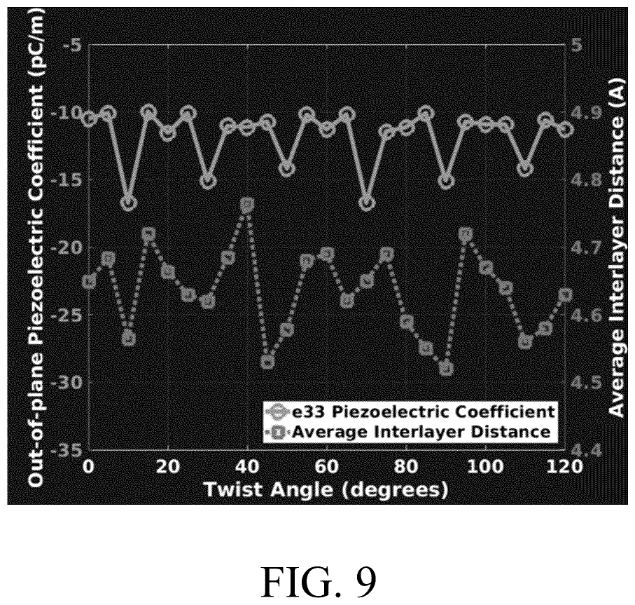

Out-of-plane piezoelectric response arises from asymmetric charge distribution and broken inversion symmetry in heterobilayers along the z-direction. This is illustrated in FIGS. 8 and 9 for the h-BN/h-BP and h-BN/MoS2 heterostructures, respectively. In contrast to the in-plane coefficients, e₃₃ is dependent on the average interlayer distance. That in turn is fluctuating with the corrugations of both layers (see also, FIG. 5).

### IV. Conclusory Discussion and Examples

Among other concepts, an efficient DFTB-based approach is described that allows converged piezoelectric coefficient predictions of relaxed, twisted heterobilayer systems beyond 1,000 atoms on a single compute node. The prediction of twist angle dependent piezoelectric coefficients of heterobilayers converges with supercell sizes of around 600 atoms only. The described results unveil controllable in-plane piezoelectricity in both h-BN/h-BP and h-BN/MoS2 heterobilayer structures. The corresponding out-of-plane piezoelectric response, on the other hand, depends on the interlayer distance. That distance fluctuates with pronounced monolayer corrugations, which do not show systematic twist angle dependence. Therefore, in first order, e₃₃ is independent of the twist angle and mostly constant.

Accordingly, a DFTB method for advantageously predicting piezoelectric coefficients of fully relaxed, twisted 2D heterobilayer materials is described. The DFTB method density provides as a more efficient method to predict the properties of materials, interfaces, solutions, and devices. Its numerical efficiency is much improved over DFT methods since the most expensive interaction integrals are parameterized instead of explicitly solved with respect to the full 3D charge density information.

A. Example Applications of the Described Methods

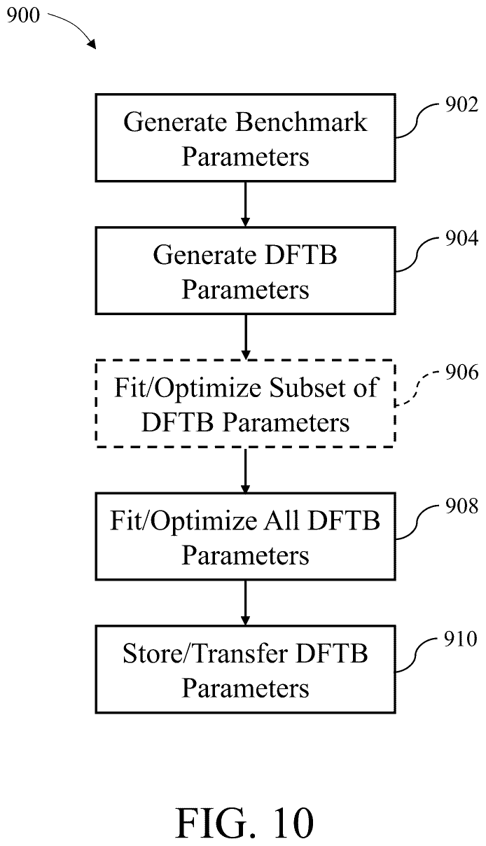

Described above are systems and methods capable of generating computational models of material systems. FIG. 10 illustrates one such method (900). At step (902), a set of benchmark parameters is generated. The benchmark parameters are indicative of material properties of a reference material system through performance of at least one of a simulation of, or an experiment on, a reduced subset of the larger reference material system. As described herein, examples of reference material systems may refer to any material such as, but without being limited to, heterobilayer materials, monolayer materials, dimers of pairs of atoms, heterojunctions, two-dimensional materials, three-dimensional materials, or materials having defects. The material properties can include, but are not limited to, band structures, piezoelectric coefficients, screening constant, charge distributions, optoelectronic parameters, or mechanoelectrical parameters. The material parameters can include, but are not limited to, at least one of electronic parameters, repulsive potentials, ionic parameters, or ideal distance between coupling atoms. In some embodiments, generating the set of benchmark parameters includes performing a density functional theory (DFT) simulation of a subset of the reference material system.

At step (904), the method includes generating a plurality of DFTB parameters for the reference material system. In some embodiments, this plurality of DFTB parameters may include a reduced subset of parameters, and in some embodiments, may be of a reduced subset of the reference material system. Optionally, at step (906), the method can include optimizing a subset of the plurality of DFTB parameters to generate a second simulation output of the subset of the reference material system according to a target accuracy relative to the set of benchmark parameters. The goal may be to achieve results which are close to the benchmark parameters. Whether the results are close enough to the benchmark parameters is dependent on the materials and the particular application. As such, the target accuracy may be pre-defined by a user. In one illustrative example, the target accuracy may be to achieve one or more of the parameters within 10% deviation of the respective benchmark parameter. In another illustrative example, the target accuracy may be less than 10% deviation or greater than 10% deviation. In applications where the reference material system includes two or more materials and a material interface defined between the two or more materials, the subset of the reference material system optimized by the first optimization routine can optionally include the two or more materials but not the material interface. Further, “two or more materials” can include at least one material layer and at least one defect defined by the at least one material layer.

At step (908), an optimization routine may be performed to adjust each DFTB parameter of the plurality of DFTB parameters to again improve their accuracy relative to the set of benchmark parameters of the reference material system. At this step (908) a larger set of DFTB parameters may be optimized against the entire reference material system as opposed to only a subset of the reference material system. In some embodiments of the method, the optimization routine can include selecting a repulsive potential of two coupling atoms of the reference material system, the repulsive potential to the reference material system while all parameters of the set of DFTB parameters are held static to generate a fitted repulsive potential and storing the fitted repulsive potential as a new parameter of the set of DFTB parameters. The two coupling atoms can be of equal or different kinds within the reference material system. Finally, at step (910), the method can include storing an optimized set of DFTB parameters corresponding to the material properties of the reference material system. In some applications, storing the optimized set of DFTB parameters includes assigning the optimized set of DFTB parameters to a transferability space, wherein the transferability space correlates the optimized set of DFTB parameters with one or more applicable material systems or material interfaces. Optionally, the method can also include the step of transferring the optimized set of DFTB parameters to a second, similar reference material system for which it is applicable to.

In another example application, after the completion of step (902), the following steps may be undertaken until the DFTB results from the DFTB parameters of all considered scenarios agree well enough with the benchmarking results: (a) fitting the DFTB parameters with the repulsive potentials kept fixed to get DFTB parameters to provide results within a target accuracy of the benchmark results, and (b) fitting all repulsive potentials while the DFTB parameters of are kept fixed to get the best possible agreement of the DFTB-derived results with the benchmarking results.

B. Example Systems for Performing the Described Methods

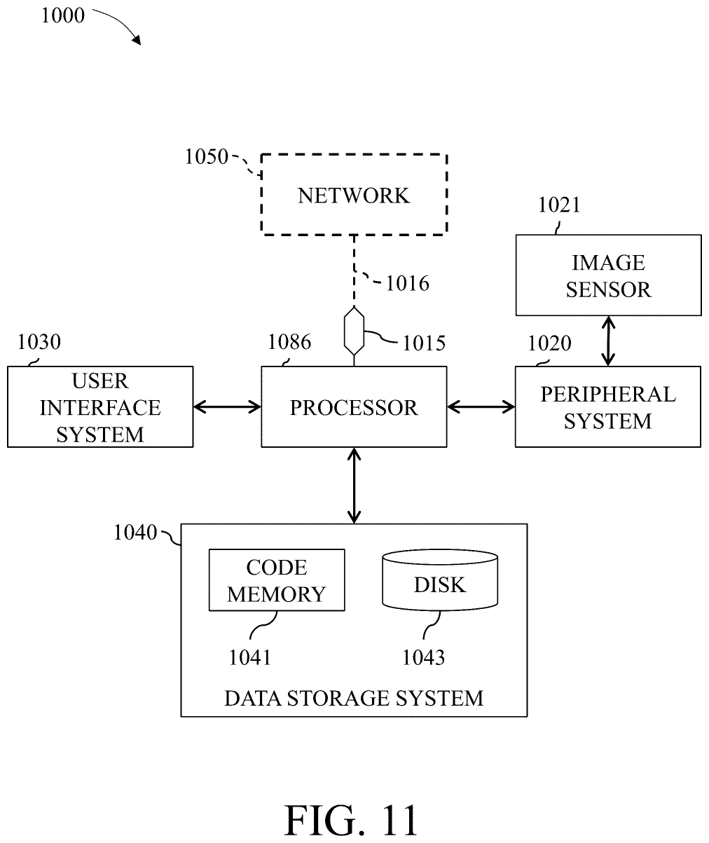

FIG. 11 is a high-level block diagram showing the components of an exemplary data-processing system 1000 for analyzing data and performing other procedural methods and analyses described herein, and related components. The system includes a processor 1086, a peripheral system 1020, a user interface system 1030, and a data storage system 1040. The peripheral system 1020, the user interface system 1030 and the data storage system 1040 are communicatively connected to the processor 1086. Processor 1086 can be communicatively connected to network 1050 (shown in phantom), e.g., the Internet or a leased line, as discussed below. The imaging and 3D point data described in the Papers may be obtained using imaging sensors 1021 and/or displayed using display units (included in user interface system 1030) which can each include one or more of systems 1086, 1020, 1030, 1040, and can each connect to one or more network(s) 1050. Processor 1086, and other processing devices described herein, can each include one or more microprocessors, microcontrollers, field-programmable gate arrays (FPGAs), application-specific integrated circuits (ASICs), programmable logic devices (PLDs), programmable logic arrays (PLAs), programmable array logic devices (PALs), or digital signal processors (DSPs).

Processor 1086 can implement processes of various aspects described herein. Processor 1086 can be or include one or more device(s) for automatically operating on data, e.g., a central processing unit (CPU), microcontroller (MCU), desktop computer, laptop computer, mainframe computer, personal digital assistant, digital camera, cellular phone, smartphone, or any other device for processing data, managing data, or handling data, whether implemented with electrical, magnetic, optical, biological components, or otherwise. Processor 1086 can include Harvard-architecture components, modified-Harvard-architecture components, or Von-Neumann-architecture components.

The phrase “communicatively connected” includes any type of connection, wired or wireless, for communicating data between devices or processors. These devices or processors can be located in physical proximity or not. For example, subsystems such as peripheral system 1020, user interface system 1030, and data storage system 1040 are shown separately from the data processing system 1086 but can be stored completely or partially within the data processing system 1086.

The peripheral system 1020 can include one or more devices configured to provide digital content records to the processor 1086. For example, the peripheral system 1020 can include digital still cameras, digital video cameras, cellular phones, or other data processors. The processor 1086, upon receipt of digital content records from a device in the peripheral system 1020, can store such digital content records in the data storage system 1040.

The user interface system 1030 can include a mouse, a keyboard, another computer (connected, e.g., via a network or a null-modem cable), or any device or combination of devices from which data is input to the processor 1086. The user interface system 1030 also can include a display device, a processor-accessible memory, or any device or combination of devices to which data is output by the processor 1086. The user interface system 1030 and the data storage system 1040 can share a processor-accessible memory.

In various aspects, processor 1086 includes or is connected to communication interface 1015 that is coupled via network link 1016 (shown in phantom) to network 1050. For example, communication interface 1015 can include an integrated services digital network (ISDN) terminal adapter or a modem to communicate data via a telephone line; a network interface to communicate data via a local-area network (LAN), e.g., an Ethernet LAN, or wide-area network (WAN); or a radio to communicate data via a wireless link, e.g., WiFi or GSM. Communication interface 1015 sends and receives electrical, electromagnetic or optical signals that carry digital or analog data streams representing various types of information across network link 1016 to network 1050. Network link 1016 can be connected to network 1050 via a switch, gateway, hub, router, or other networking device.

Processor 1086 can send messages and receive data, including program code, through network 1050, network link 1016 and communication interface 1015. For example, a server can store requested code for an application program (e.g., a JAVA applet) on a tangible non-volatile computer-readable storage medium to which it is connected. The server can retrieve the code from the medium and transmit it through network 1050 to communication interface 1015. The received code can be executed by processor 1086 as it is received, or stored in data storage system 1040 for later execution.

Data storage system 1040 can include or be communicatively connected with one or more processor-accessible memories configured to store information. The memories can be, e.g., within a chassis or as parts of a distributed system. The phrase “processor-accessible memory” is intended to include any data storage device to or from which processor 1086 can transfer data (using appropriate components of peripheral system 1020), whether volatile or nonvolatile; removable or fixed; electronic, magnetic, optical, chemical, mechanical, or otherwise. Exemplary processor-accessible memories include but are not limited to: registers, floppy disks, hard disks, tapes, bar codes, Compact Discs, DVDs, read-only memories (ROM), erasable programmable read-only memories (EPROM, EEPROM, or Flash), and random-access memories (RAMs). One of the processor-accessible memories in the data storage system 1040 can be a tangible non-transitory computer-readable storage medium, i.e., a non-transitory device or article of manufacture that participates in storing instructions that can be provided to processor 1086 for execution.

In an example, data storage system 1040 includes code memory 1041, e.g., a RAM, and disk 1043, e.g., a tangible computer-readable rotational storage device such as a hard drive. Computer program instructions are read into code memory 1041 from disk 1043. Processor 1086 then executes one or more sequences of the computer program instructions loaded into code memory 1041, as a result performing process steps described herein. In this way, processor 1086 carries out a computer implemented process. For example, steps of methods described herein, blocks of the flowchart illustrations or block diagrams herein, and combinations of those, can be implemented by computer program instructions. Code memory 1041 can also store data, such as material property parameters, pre-defined user target accuracy data, or other forms of data associated with the described methods, or can store only code.

Various aspects described herein may be embodied as systems or methods. Accordingly, various aspects herein may take the form of an entirely hardware aspect, an entirely software aspect (including firmware, resident software, micro-code, etc.), or an aspect combining software and hardware aspects These aspects can all generally be referred to herein as a “service,” “circuit,” “circuitry,” “module,” or “system.”

Furthermore, various aspects herein may be embodied as computer program products including computer readable program code stored on a tangible non-transitory computer readable medium. Such a medium can be manufactured as is conventional for such articles, e.g., by pressing a CD-ROM. The program code includes computer program instructions that can be loaded into processor 1086 (and possibly also other processors), to cause functions, acts, or operational steps of various aspects herein to be performed by the processor 1086 (or other processor). Computer program code for carrying out operations for various aspects described herein may be written in any combination of one or more programming language(s), and can be loaded from disk 1043 into code memory 1041 for execution. The program code may execute, e.g., entirely on processor 1086, partly on processor 1086 and partly on a remote computer connected to network 1050, or entirely on the remote computer.

While examples, one or more representative embodiments and specific forms of the disclosure have been illustrated and described in detail in the drawings and foregoing description, the same is to be considered as illustrative and not restrictive or limiting. The description of particular features in one embodiment does not imply that those particular features are necessarily limited to that one embodiment. Some or all of the features of one embodiment can be used in combination with some or all of the features of other embodiments as would be understood by one of ordinary skill in the art, whether or not explicitly described as such. One or more exemplary embodiments have been shown and described, and all changes and modifications that come within the spirit of the disclosure are desired to be protected.

I/We claim:

1. A method of generating a computational model, comprising:
(a) generating a set of benchmark parameters indicative of material properties of a reference material system through performance of at least one of a simulation of, or an experiment on, a subset of the reference material system;
(b) generating a plurality of DFTB parameters for the reference material system;
(c) performing an optimization routine to adjust each DFTB parameter of the plurality of DFTB parameters to improve accuracy relative to the set of benchmark parameters of the reference material system; and
(d) storing an optimized set of DFTB parameters corresponding to the material properties of the reference material system.

2. The method of claim 1, wherein generating the set of benchmark parameters includes performing a density functional theory (DFT) simulation of a subset of the reference material system.

3. The method of claim 1, wherein upon generating a plurality of DFTB parameters, and before performing an optimization routine to adjust each DFTB parameter of the plurality of DFTB parameters, the method comprises:
optimizing a subset of the plurality of DFTB parameters to generate a second simulation output of the subset of the reference material system according to a target accuracy relative to the set of benchmark parameters.

4. The method of claim 1, wherein the set of benchmark parameters includes at least one of a band structure, a piezoelectric coefficient, a screening constant, a charge distribution, an optoelectronic parameter, or a mechanoelectrical parameter of the reference material system.

5. The method of claim 1, wherein storing the optimized set of DFTB parameters includes assigning the optimized set of DFTB parameters to a transferability space, wherein the transferability space correlates the optimized set of DFTB parameters with one or more applicable material systems or material interfaces.

6. The method of claim 1, wherein the plurality of DFTB parameters of the reference material system includes at least one of electronic parameters, repulsive potentials, ionic parameters, or ideal distance between coupling atoms.

7. The method of claim 1, wherein the plurality of DFTB parameters includes repulsive potentials of the reference material system, wherein the optimization routine includes:
(a) selecting a repulsive potential of two coupling atoms of the reference material system;
(b) fitting the repulsive potential to the reference material system while all parameters of the set of DFTB parameters are held static to generate a fitted repulsive potential;
(c) storing the fitted repulsive potential as a new parameter of the set of DFTB parameters.

8. The method of claim 7, wherein the two coupling atoms are of equal or different kinds within the reference material system.

9. The method of claim 1, further comprising:
transferring the optimized set of DFTB parameters to a second reference material system.

10. A method of generating a computational model, comprising:
(a) generating a set of benchmark parameters indicative of material properties of a reference material system through performance of at least one of a simulation of, or an experiment on, a subset of the reference material system;
(b) generating a set of DFTB parameters;
(c) initiating a first optimization routine to generate an optimized subset of density-functional tight-binding (DFTB) parameters from a subset of the set of DFTB parameters to improve accuracy relative to the set of benchmark parameters for a subset of the reference material system;
(d) combining the optimized subset of DFTB parameters with the set of DFTB parameters; and
(d) initiating a second optimization routine on the set of DFTB parameters to generate an optimized full set of DFTB parameters to improve accuracy relative to the set of benchmark parameters for the reference material system.

12. The method of claim 10, wherein generating the set of benchmark parameters includes performing a density functional theory (DFT) simulation of a subset of the reference material system.

13. The method of claim 10, wherein the set of benchmark parameters includes at least one of a band structure, a piezoelectric coefficient, a screening constant, a charge distribution, an optoelectronic parameter, or a mechanoelectrical parameter of the reference material system.

14. The method of claim 10, further comprising:
assigning the optimized full set of DFTB parameters to a transferability space, wherein the transferability space correlates the optimized full set of DFTB parameters with one or more applicable material systems or material interfaces.

15. The method of claim 10, wherein the optimized full set of DFTB parameters of the reference material system includes at least one of electronic parameters, repulsive potentials, ionic parameters, or ideal distance between coupling atoms.

16. The method of claim 10, wherein the optimized subset of DFTB parameters includes repulsive potentials of the reference material system, wherein the second optimization routine includes:
(a) selecting a repulsive potential of two coupling atoms of the reference material system;
(b) fitting the repulsive potential to the reference material system while all parameters of the set of DFTB parameters are held static to generate a fitted repulsive potential; and
(c) storing the fitted repulsive potential as a new parameter of the set of DFTB parameters.

17. The method of claim 10, wherein the reference material system includes two or more materials and a material interface defined between the two or more materials, wherein the subset of the reference material system optimized by the first optimization routine includes the two or more materials but not the material interface.

18. The method of claim 17, wherein the two or more materials includes at least one material layer and at least one defect defined by the at least one material layer.

19. A method of generating a computational model, comprising:
(a) generating a set of benchmark parameters indicative of material properties of a reference material system through performance of at least one of a simulation of, or an experiment on, a subset of the reference material system;
(b) generating an initial set of density-functional tight-binding (DFTB) parameters;
(c) initiating a first optimization routine to generate a first optimized set of DFTB parameters from the initial set of DFTB parameters to improve accuracy relative to the set of benchmark parameters for a subset of the reference material system; and
(d) initiating a second optimization routine on the first optimized set of DFTB parameters to generate a second optimized set of DFTB parameters to improve accuracy relative to the set of benchmark parameters for the reference material system, wherein the first optimized set of DFTB parameters includes repulsive potentials each corresponding to two coupling atoms of the reference material system, wherein the second optimization routine includes:
(i) selecting a repulsive potential of the reference material system;
(ii) fitting the repulsive potential to the reference material system while all parameters of the set of DFTB parameters are held static to generate a fitted repulsive potential; and
(iii) storing the fitted repulsive potential as a new parameter of the second optimized set of DFTB parameters.

20. The method of claim 10, wherein the reference material system includes two or more materials and a material interface defined between the two or more materials, wherein the subset of the reference material system optimized by the first optimization routine includes the two or more materials but not the material interface.
